(19) United States
(12) Patent Application Publication
(10) Pub. No.: US 2016/0004419 A1
(43) Pub. Date: Jan. 7, 2016

(54) MONITORING DEVICE AND INPUT OPERATION SUPPORT DEVICE

(71) Applicant: FUJITSU LIMITED, Kawasaki-shi (JP)

(72) Inventors: Daiya Nakamura, Kawasaki (JP); Mihoko Maeda, Kawasaki (JP); Jiyu Kushihara, Kawasaki (JP)

(73) Assignee: Fujitsu Limited, Kawasaki (JP)

(21) Appl. No.: 14/723,508

(22) Filed: May 28, 2015

(30) Foreign Application Priority Data
Jul. 7, 2014 (JP) 2014-139647

(51) Int. Cl. G06F 3/0484; G06F 17/27

(52) U.S. Cl. CPC G06F 3/04847; G06F 3/04842; G06F 17/276

(57) ABSTRACT

A monitoring device included a processor. The processor is configured to monitor a state of a first device. The processor is configured to receive an operation command input partway. The operation command is for operating the first device. The processor is configured to select, depending on the state of the first device, a prioritized completion candidate from among a plurality of completion candidates likely to be included in the operation command. The prioritized completion candidate is to be displayed in a display unit in priority to other completion candidates among the plurality of completion candidates. The processor is configured to output information regarding the prioritized completion candidate.

### CROSS-REFERENCE TO RELATED APPLICATION

This application is based upon and claims the benefit of priority of the prior Japanese Patent Application No. 2014-139647, filed on Jul. 7, 2014, the entire contents of which are incorporated herein by reference.

### FIELD

The embodiments discussed herein are related to a monitoring device and an input operation support device.

### BACKGROUND

In a device (appliance device) such as a storage device or a network switch, specialized in a particular function, in many cases a graphical user interface (GUI) or a command line interface (CLI) is provided as an interface for a management or setting work desired for a daily operation, such as a setting operation or information display for the relevant device.

In GUI, in addition to characters, images such as icons are displayed and an operation target is visually clarified. In addition, using a mouse or the like, an operation is relatively simply performed. Therefore, even if not being a person of skill, an operator relatively easily utilizes GUI. However, in a case where a large number of complicated operations or continuous operations are desired, it is very hard to use GUI.

In contrast, CLI has comfortable operability and is convenient for performing the combination of complicated operations or continuous operations, difficult for GUI to deal with. Therefore, in routine operational management or setting works, CLI is used in many cases.

Related techniques are disclosed in, for example, Japanese Laid-open Patent Publication No. 2002-351600, Japanese Laid-open Patent Publication No. 7-253867, Japanese Laid-open Patent Publication No. 2011-65617, and Japanese Laid-open Patent Publication No. 2000-3375.

However, in addition to it that it is desirable to get used to the operation of CLI to some extent, there is little visual information therein. Therefore, in CLI, an operation mistake easily occurs compared with GUI. In particular, in an appliance device, in addition to it that a large number of similar operations are prepared, parts of the same type or similar parts are installed in the device by hundreds or thousands in some cases.

Therefore, in order to perform the management or setting work for the relevant device using CLI, it is desirable to adequately select and input a desirable command from among a large number of similar commands. Furthermore, it is desirable to correctly specify a part number indicating an intended part, from among several thousands of parts, in accordance with the format of a CLI command. At the time of such specification, a load on an operator increases with an increase in the number of commands or parts serving as choices and accordingly, an operation mistake easily occurs.

### SUMMARY

According to an aspect of the present invention, provided is a monitoring device including a processor. The processor is configured to monitor a state of a first device. The processor is configured to receive an operation command input partway. The operation command is for operating the first device. The processor is configured to select, depending on the state of the first device, a prioritized completion candidate from among a plurality of completion candidates likely to be included in the operation command. The prioritized completion candidate is to be displayed in a display unit in priority to other completion candidates among the plurality of completion candidates. The processor is configured to output information regarding the prioritized completion candidate.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a completion function of CLI;

FIG. 2 is a diagram illustrating a completion function of CLI;

FIG. 3 is a diagram illustrating a completion function of CLI;

FIG. 4 is a diagram illustrating a completion function of CLI;

FIG. 5 is a diagram illustrating a completion function of CLI according to a first embodiment;

FIG. 6 is a diagram illustrating a completion function of CLI according to the first embodiment;

FIG. 7 is a diagram illustrating a completion function of CLI according to the first embodiment;

FIG. 8 is a diagram illustrating a hardware configuration of a storage device to which a monitoring device according to the first embodiment is applied and an input operation support device according to the first embodiment;

FIG. 9 is a diagram illustrating a functional configuration of the storage device illustrated in FIG. 8;

FIG. 10 is a diagram illustrating configurations of the monitoring device applied to the storage device and the input operation support device illustrated in FIG. 8;

FIG. 11 is a diagram illustrating an example of a state information management table according to the first embodiment;

FIG. 12 is a diagram illustrating an example of a state information management table according to the first embodiment;

FIG. 13 is a diagram illustrating an example of a state information management table according to the first embodiment;

FIG. 14 is a diagram illustrating an example of a completion rule according to the first embodiment;

FIG. 15 is a flowchart illustrating an operation of the monitoring device according to the first embodiment; and

FIG. 16 is a flowchart illustrating operations of the monitoring device and the input operation support device according to the first embodiment.

### DESCRIPTION OF EMBODIMENTS

In what follows, embodiments of a monitoring device and an input operation support device will be described in detail with reference to drawings. The embodiments are just exemplifications and there is no intention of excluding various kinds of examples of a modification and application of technologies, not clearly specified in the embodiments. In other words, the embodiments may be variously modified and implemented without departing from the scope thereof. Each drawing is depicted without intention to only include configuration elements illustrated in the relevant drawing, may include another function. Individual embodiments may be arbitrarily combined within a scope where contents of processing are consistent.

### First Embodiment

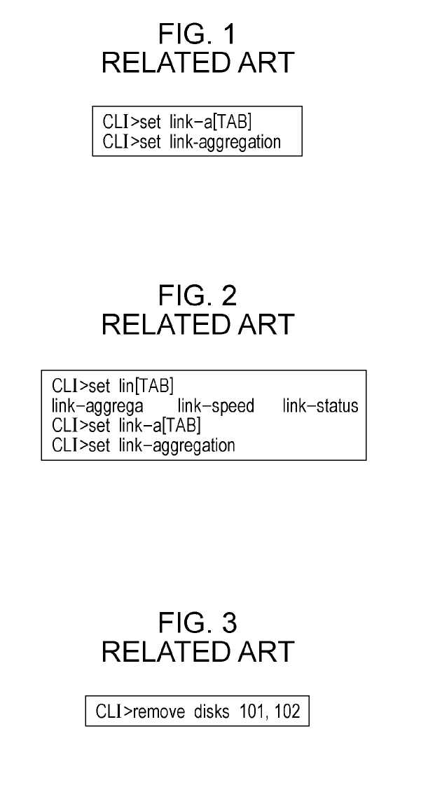

First, a general CLI completion function will be described with reference to FIG. 1 to FIG. 4. FIG. 1 to FIG. 4 are diagrams each specifically illustrating a general completion function of CLI.

In CLI, a completion function is widely implemented as a technology for realizing an efficient input operation. With the completion function, it is possible for an operator to abbreviate or omit input of a command name or a file name at the time of the input of a command by pressing down a particular key (for example, a TAB key) on a command line, and to easily execute a command input. In a case where, at the time of inputting, for example, a command of “set link-aggregation”, the operator presses down the TAB key after inputting up to “set link-a” as illustrated in FIG. 1 (see the first line), “ggregation” is autocompleted (see the second line) and it is possible to efficiently perform an input work. In the drawing, “[TAB]” indicates a press-down operation of the TAB key.

The completion function includes a function to display, in a case where a plurality of completion candidates exist at the time of the press-down operation of the TAB key, the relevant completion candidates on a screen and prompt the operator to input a subsequent character. For example, as illustrated in FIG. 2, if the operator presses down the TAB key after inputting up to “set lin” (see the first line), three completion candidates of “link-aggrega”, “link-speed”, and “link-status” are displayed (see the second line). If the operator who refers to the completion candidates continuously inputs “k-a[TAB]” subsequent to “set lin” (see the third line), “ggregation” is autocompleted in the same way as the example of FIG. 1 (see the fourth line).

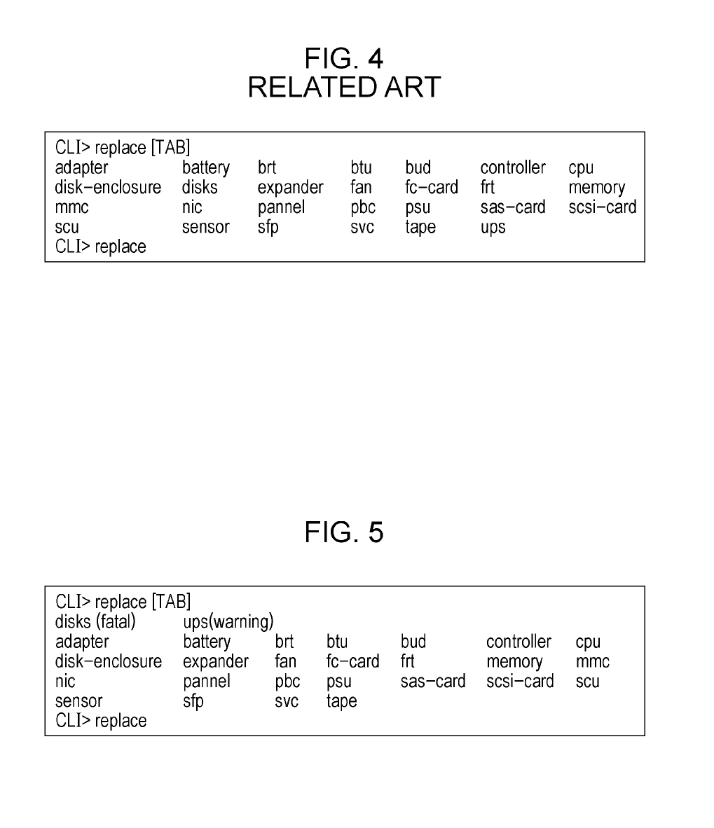

As described above, names (a command name, a part type name, a part name, and so forth) accessible by a user are held by the completion function, thereby performing autocomplete for a command and so forth. At that time, in a case where a plurality of completion candidates exist, a method of displaying the completion candidates (input candidates) in alphabetical order is used (see FIG. 2 and FIG. 4). In addition to the relevant method, a method of performing display on the basis of preliminarily set association information of commands, and a method of performing display on the basis of usage histories of commands, and so forth exist. While these methods are effective as assistance in facilitating an input operation utilizing a CLI function, it is hard to say that these methods are effective for avoiding the above-mentioned operation mistakes.

For example, in a redundant arrays of inexpensive disks (RAID) device, in a case where a work for separating bad disks from the relevant RAID device is implemented using CLI, the operator performs the following input operation. It is desirable that, as illustrated in, for example, FIG. 3, the operator specifies and inputs, as parameters, the part numbers (disk numbers: “101, 102” in FIG. 3) of disks to be separated from the relevant RAID device after inputting a command of “remove disks” on the command line.

At this time, in a case where, by any chance, the operator makes a mistake in the specification of the part numbers of disks and specifies and inputs “100, 102”, a disk having the part number “100” not to be separated by right turns out to be separated and there is a possibility that a significant system failure is caused. In a case where, instead of the command of “remove disks” to be executed by right, a command of “remove disk-enclosures” is erroneously specified, input, and executed, a significant system failure may be caused. Therefore, it is desirable to reliably suppress the occurrences of such operation mistakes as described above and to enable the input of an operation command to be correctly performed without increasing a load on the operator even if the number of commands or parts serving as choices is increased.

Therefore, according to the present embodiment, state information of an operation target device, which is an element important in managing the operation target device such as an appliance device, is used in order to suppress the occurrences of operation mistakes and so forth by expanding the general CLI completion function described above with reference to FIG. 1 to FIG. 4. That is, completion candidates of an operation command are dynamically selected, based on real-time state information at the time point of executing the relevant operation command, and displayed in a display unit. Therefore, it is possible to determine and display, in real time, candidates each having a high possibility to be used by the operator at each time point. Thus, it becomes possible for the operator to use the CLI function with a smaller operation amount and adequate completion candidates (prioritized completion candidates) to be specified are preferentially displayed, thereby enabling to reliably suppress the occurrences of operation mistakes.

In a case where the operation target device operated using the CLI function is an appliance product, the frequencies of CLI commands (operation commands) to be used may widely vary depending on various kinds of states of the relevant device. For example, in a case where an error occurs in a particular part of the relevant device, the frequency of usage of a command for displaying the details of the error or a command preferably used for recovery from the error inevitably becomes high. In a case where a large number of parts of the same type are installed, the frequency of execution of a command to specify the part in which the error occurs becomes high in the same way. According to the present embodiment, the state of the operation target device is monitored, and in accordance with the state of the operation target device, completion candidates of an operation command are dynamically changed and displayed in the display unit. Thus, according to the present embodiment, based on the various kinds of state information of the device at the time of executing completion processing, commands and parameters (a part type, a part number, and so forth) whose frequencies of usage are high are preferentially displayed.

In what follows, the completion function utilizing the state information of the operation target device will be specifically described with reference to FIG. 4 to FIG. 7. FIG. 4 is a diagram specifically illustrating a general completion function of CLI and FIG. 5 to FIG. 7 are diagrams each specifically illustrating the completion function (an exemplary display of completion candidates) of CLI according to the present embodiment.

First, a completion function in a case where the CLI completion function according to the present embodiment is applied to a storage device (operation target device) and in a case where a “replace” command for replacing a part of the storage device is input will be described with reference to FIG. 4 to FIG. 6.

The “replace” command is a command for specifying a part installed in the operation target device and starting replacement processing. The format of the “replace” command is [“replace” part type, part number, part number . . . ]. In most cases, a part type and a part number specified by the operator each relate to a part in which some problem (an error, a failure, or the like) occurs.

If the operator presses down the TAB key serving as a completion key subsequent to the input of “replace”, part types (part type names) of parts currently installed in the operation target device are only displayed in alphabetical order by a usual CLI completion function, as illustrated in FIG. 4 (see the second to fifth lines in FIG. 4). At this time, part types of parts which are not installed in the operation target device are not displayed. The operator selects a part type of a part to be replaced from among the part types illustrated in the second to fifth lines in FIG. 4 and inputs the selected part type subsequent to “replace” in the sixth line in FIG. 4.

In contrast, if the same input operation as the example of FIG. 4 is performed in a case where two failed disks in a “fatal” state and an uninterruptible power supply (ups) in a “warning” state exist in the operation target device to which the completion function according to the present embodiment is applied, such display as illustrated in FIG. 5 is performed according to the present embodiment. Here, it is assumed that the disk numbers (part numbers: pieces of part information for identifying parts) of the two failed disks in the “fatal” state are “103” and “307”.

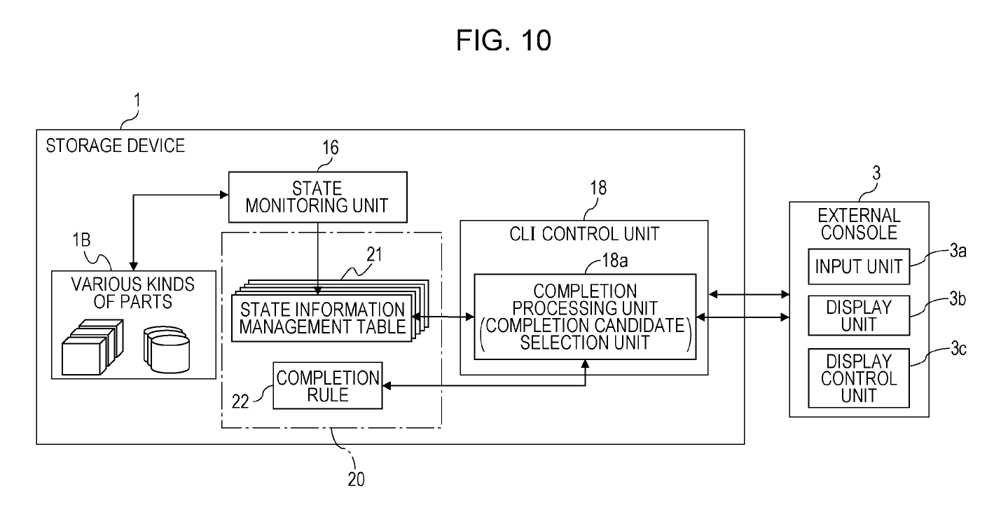

Here, it is assumed that, according to the present embodiment, the state of each part or the state of parts having each part type is information relating to, for example, the level (abnormal level) of an abnormal state that occurs in the relevant part or parts of the relevant part type. For example, four levels of “fatal”, “error”, “warning”, and “normal” are monitored as the state of each part or the state of parts having each part type, and set in state information management tables 21 described later (see FIG. 10, FIG. 11, and FIG. 13). “fatal” is a state, whose abnormal level is the highest, and is a fatal failed state in which replacement of a part is desirable. “error” is a state whose abnormal level is the second highest and in which an error manageable without replacement of a part occurs. “warning” is a state, whose abnormal level is the third highest, and is a warning state alerting of being a state in which a possibility that an error occurs is high. “normal” is a normal state in which there is no problem.

As illustrated in FIG. 5, if the operator presses down the TAB key serving as the completion key, subsequent to the input of “replace” (an operation type) (see the first line), a part type of “disks” in the “fatal” state and a part type of “ups” in the “warning” state are automatically selected by the CLI completion function according to the present embodiment, as prioritized completion candidates, from among the part types (completion candidates: see the second to fifth lines in FIG. 4) and preferentially displayed (see the second line in FIG. 5). At the same time, the state of a part having the part type of “disks”, which causes the prioritized display of the relevant part type of “disks”, is displayed as “(fatal)” (see the second line). In the same way, the state of a part having the part type of “ups”, which causes the prioritized display of the relevant part type of “ups”, is displayed as “(warning)” (see the second line). Part types in the “normal” state are displayed subsequent to the prioritized display of the part types, in alphabetical order in the same way as the example of FIG. 4 (see the third to sixth lines in FIG. 5).

In the example of FIG. 5, as a method of the prioritized display, a method of displaying part types (part type names) in descending order of abnormal level is adopted. In addition to the relevant method, a method of highlighting by changing the display color, the display size, the display luminance, or the like of a part type in accordance with the abnormal level thereof may be adopted. In a case where parts in the same abnormal level exist, part types of these parts may be displayed in alphabetical order.

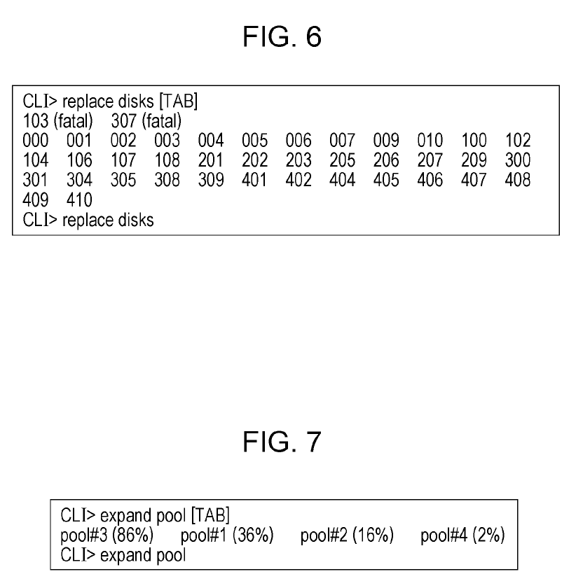

It is assumed that, as illustrated in FIG. 6, the operator who refers to the display illustrated in FIG. 5 inputs “disks” serving as a part type in the “fatal” state subsequent to “replace”, thereby performing the completion operation, in other words, the press-down operation of the TAB key (see the first line). In this case, the part numbers “103” and “307” of the failed disks (disks in the “fatal” state) are automatically selected by the CLI completion function according to the present embodiment, as the prioritized completion candidates, from among the part numbers (completion candidates) and preferentially displayed (see the second line). At the same time, the states of parts having the part numbers “103” and “307” which cause the prioritized display of the relevant part numbers “103” and “307”, are displayed as “(fatal)” (see the second line). The part numbers of disks in the “normal” state are displayed subsequent to the prioritized display of the part numbers in ascending order (see the third to sixth lines). It is possible for the operator to reliably recognize disks in the “fatal” state from among the part numbers subjected to the prioritized display in the second line FIG. 6, and it is possible for the operator to correctly input the part numbers “103” and “307” of the recognized disks subsequent to “replace disks” in the seventh line in FIG. 6.

In the example of FIG. 6, as a method of the prioritized display, a method of displaying part numbers (disk numbers or part information) in descending order of abnormal level is adopted. In addition to the relevant method, a method of highlighting by changing the display color, the display size, the display luminance, or the like of a part number in accordance with the abnormal level thereof may be adopted. In a case where parts in the same abnormal level exist, part numbers of these parts may be displayed in ascending order (or alphabetical order).

Next, a completion function in a case where the CLI completion function according to the present embodiment is applied to a storage device and in a case where an “expand pool” command for expanding a storage pool of the storage device is input will be described with reference to FIG. 7.

The “expand pool” command is a command for specifying a storage pool installed in the storage device, expanding the specified storage pool to solve capacity shortage of the relevant storage pool. Therefore, in many cases, the storage pool specified by the operator is a pool in which a possibility that a capacity shortage occurs is high, in other words, a pool whose usage rate is high (whose usage amount is large). While not illustrated here, if the operator presses down the TAB key subsequent to the input of “expand pool”, the pool numbers (part numbers: for example, “pool#1”, “pool#2”, . . . ) of storage pools currently installed in the operation target device are only displayed in ascending order by the usual CLI completion function.

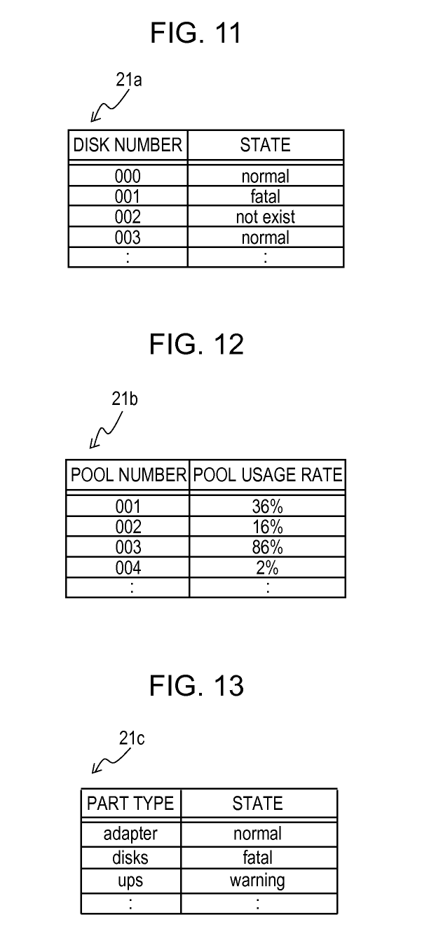

In contrast, in the operation target device to which the completion function according to the present embodiment is applied, the usage amount or usage rate (numerical information relating to a part) of each storage pool is monitored as the state of the relevant part and set in the state information management tables 21 described later (see FIG. 10 and FIG. 12). Here, it is assumed that the usage rates of storage pools having pool numbers “pool#1”, “pool#2”, “pool#3”, and “pool#4” are 36%, 16%, 86%, and 2%, respectively.

As illustrated in FIG. 7, if the operator presses down the TAB key serving as the completion key subsequent to the input of “expand pool” (an operation type) (see the first line), the pool numbers (pieces of part information: completion candidates) of all the storage pools installed in the operation target device are selected as prioritized completion candidates by the CLI completion function according to the present embodiment, and displayed in descending order of usage rate (descending order), that is, a pool number of a storage pool having a higher usage rate is preferentially displayed (see the second line). At the same time, a usage rate (usage amount) serving as the state of each storage pool is displayed (see the second line). It is possible for the operator to reliably recognize the pool number of a storage pool whose usage rate is high from among the pool numbers subjected to the prioritized display in the second line in FIG. 7, and it is possible for the operator to correctly input the recognized pool number subsequent to “expand pool” in the third line in FIG. 7.

In the example of FIG. 7, as a method of the prioritized display, a method of displaying pool numbers in descending order of usage rate is adopted. In addition to the relevant method, a method of highlighting by changing the display color, the display size, or the display luminance, or the like of a pool number in accordance with the usage rate thereof may be adopted. In a case where pool numbers of the same usage rate exist, these pool numbers may be displayed in ascending order.

As described above, using the CLI completion function according to the present embodiment, the display of the completion candidates (in particular, prioritized completion candidates) is enabled to be dynamically changed in accordance with the state of the operation target device, thereby enabling to reliably suppress the occurrences of operation mistakes by the operator in managing an appliance. Therefore, it becomes possible to correctly perform the input of an operation command without increasing a load on the operator even if the number of commands or parts serving as choices is increased.

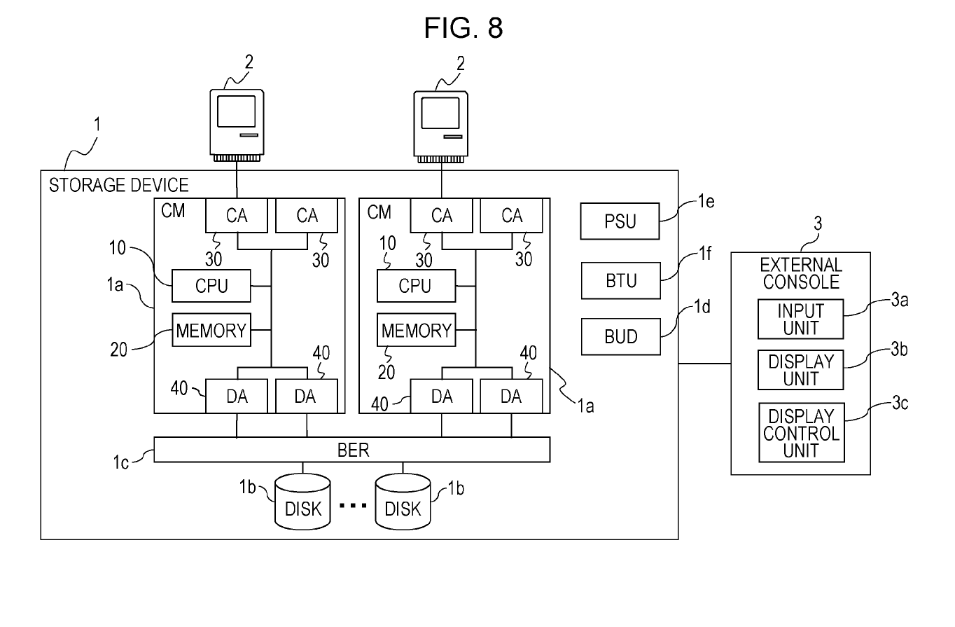

The hardware configuration of a storage device 1 to which the monitoring device and the input operation support device according to the present embodiment are applied will be described with reference to FIG. 8. FIG. 8 is a diagram illustrating a hardware configuration of the storage device 1. The storage device 1 is an appliance device serving as an operation target device into which an operation command is input using the CLI completion function of the input operation support device according to the present embodiment and which is operated by the relevant operation command.

The storage device 1 illustrated in FIG. 8 is communicably connected to one or more (two in the present embodiment) host computers 2. Each of the host computers 2 is, for example, an information processing device equipped with a server function and transmits and receives commands to and from the storage device 1. By transmitting an input or output request (I/O request) such as, for example, a read/write command to the storage device 1, the host computers 2 each write data into a volume provided by the storage device 1 or read data from the relevant volume.

In response to the input or output requests for the volume, received from the host computers 2, the storage device 1 performs processing operations such as reading data from real storage corresponding to the relevant volume and writing data thereto. The storage device 1 includes a plurality of (two in the present embodiment) controller modules (CM) 1a, a plurality of disks (physical disks) 1b, and a back end router (BER) is that establishes communicable connection between the CMs 1a and the disks 1b. Furthermore, in the storage device 1, in addition to a backup disk (BUD) id used for data backup, a power supply unit (PSU) le used for performing power supply, a battery unit (BTU) if, and so forth are provided.

Storage devices such as, for example, hard disk drives (HDDs) or solid state drives (SSDs) are used as the disks 1b, and it is possible to configure a RAID using a plurality of storage devices. Each disk 1b is connected to a plurality of (two in the drawing) device adapters (DAs) 40 in each CM 1a through the BER 1c. Each CM 1a may access each disk 1b to write data thereto and read data therefrom. In other words, by connecting each CM 1a to each disk 1b, an access path to each disk 1b is made redundant.

Each CM 1a is a controller (storage control device) that controls an operation within the storage device 1, and each CM 1a performs various kinds of control such as control of access to the disks 1b, in accordance with input or output requests transmitted from the host computers 2. The CMs 1a have configurations roughly equal to each other. The CMs 1a are duplexed and usually one of the duplexed CMs 1a performs various kinds of control as a primary CM 1a. At the time of the failure of this primary CM 1a, a secondary CM is takes over an operation as a primary CM 1a.

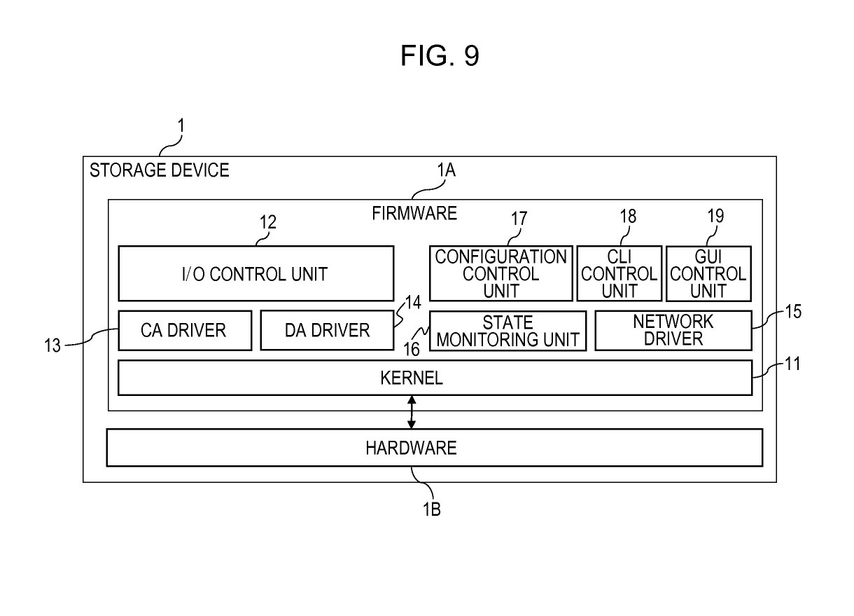

Each CM 1a is connected to the corresponding host computer 2 through a channel adapter (CA) 30. Each CM 1a receives a command such as a read/write command transmitted from the corresponding host computer 2 and controls the disks 1b through the DAs 40 and the BER 1c using the function of an input/output (I/O) control unit 12 described later (see FIG. 9). The CMs 1a are connected to each other through an interface (not illustrated) such as a peripheral component interconnect (PCI) Express.

As illustrated in FIG. 8, in addition to including the CAs 30 and the DAs 40 described above, each CM 1a includes a central processing unit (CPU) 10 and a memory 20.

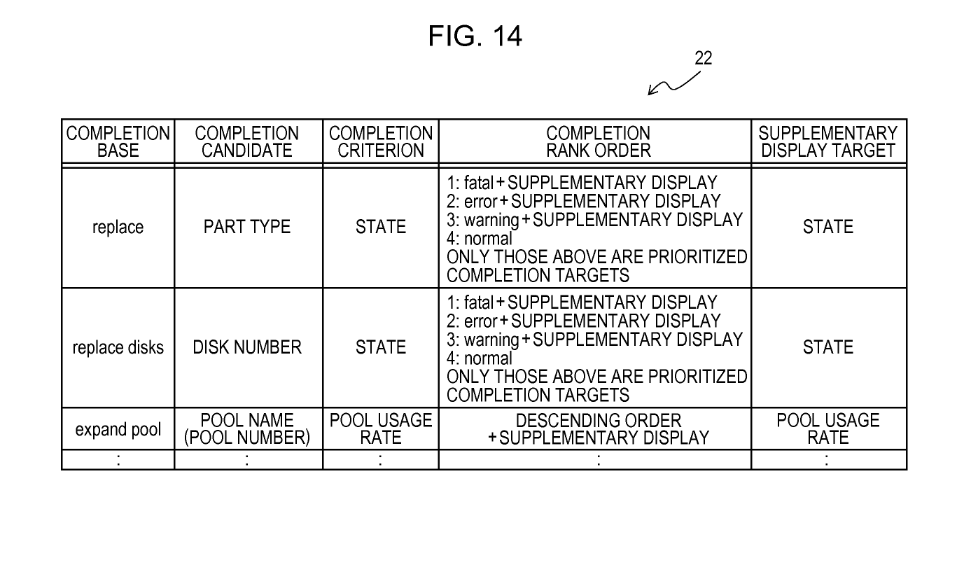

The memory 20 (storage unit) is a storage device such as a random access memory (RAM), which temporarily stores therein various kinds of data and programs, and includes a memory area and a cache area (not illustrated). In the cache area, data (input data) received from the corresponding host computer 2 and data (output data) to be transmitted to the corresponding host computer 2 are temporarily stored. In the memory area, programs (including a monitoring program) to be executed by the CPU 10 and various kinds of data used in the execution of the relevant programs are temporarily stored. The various kinds of data used in the execution of the relevant programs and stored in the memory area include the state information management tables 21 described later with reference to FIG. 10 to FIG. 13 and a completion rule 22 described later with reference to FIG. 10 and FIG. 14. Furthermore, a plurality of completion candidates (for example, the part type, the part number, the pool number, and so forth described above with reference to FIG. 5 to FIG. 7) likely to be included in an operation command for the storage device 1 and information relating to the relevant completion candidates are stored in the memory area.

An external console 3 that functions as the input operation support device according to the present embodiment is connected to the storage device 1. The external console 3 may be communicably connected to the storage device 1 through a serial cable or through a network such as a local area network (LAN). The external console 3 is an input and output device used by the operator at the time of inputting an operation command for the storage device 1. In order to realize the CLI function and a GUI function, the external console 3 includes an input unit 3a such as a keyboard or a mouse, a display unit 3b such as a liquid crystal display or a cathode ray tube (CRT), and a display control unit 3c that controls the display state of the relevant display unit 3b. The input unit 3a is operated by the operator, who refers to the display unit 3b, and inputs various kinds of instructions including an operation command for the storage device 1.

Next, the functional configuration of the storage device 1 illustrated in FIG. 8 will be described with reference to FIG. 9. FIG. 9 is a diagram illustrating the functional configuration of the storage device 1 illustrated in FIG. 8. In FIG. 9, a configuration of only one of the CMs 1a in FIG. 8 is illustrated.

The corresponding CPU 10 in the storage device 1 executes a plurality of programs and by executing the relevant programs, various kinds of functions are realized. The storage device 1 illustrated in FIG. 8 includes various kinds of functions illustrated in, for example, FIG. 9. The storage device 1 includes firmware 1A including a program used by the corresponding CPU 10 in the storage device 1 to realize various kinds of functions, and various kinds of hardware 1B installed in the storage device 1. The hardware 1B includes various kinds of parts whose states are to be monitored by a state monitoring unit 16 described later.

The firmware 1A includes a kernel 11 that provides the basic function of an operating system (OS). In addition, the firmware 1A includes the I/O control unit 12, a CA driver 13, a DA driver 14, a network driver 15, the state monitoring unit 16, a configuration control unit 17, a CLI control unit 18, and a GUI control unit 19, which operate on the kernel 11.

Here, the I/O control unit 12 fulfills a function to process input or output requests (I/O requests) received from the corresponding host computer 2.

The CA driver 13 fulfills a function to control the hardware of each of the CAs 30. The DA driver 14 fulfills a function to control the hardware of each of the DAs 40.

The network driver 15 controls hardware for performing network communication. The network driver 15 is connected to, for example, the external console 3 that functions as the input operation support device according to the present embodiment.

The state monitoring unit 16 fulfills a function to monitor the state of the hardware 1B (various kinds of parts) of the storage device 1 and collect various kinds of information. The state monitoring unit 16 functions as part of the monitoring device according to the present embodiment, as described later with reference to FIG. 10. The state information of the hardware 1B, which is monitored and collected by the state monitoring unit 16, is set and stored in the state information management tables 21 described later with reference to FIG. 10 to FIG. 13.

The configuration control unit 17 fulfills a function to manage various kinds of configurations (for example, a RAID group, a pool volume, and so forth) of the storage device 1.

The CLI control unit 18 fulfills a function to realize CLI and includes a completion processing unit 18a described later with reference to FIG. 10. As described later with reference to FIG. 10, the completion processing unit 18a functions as part of the input operation support device according to the present embodiment and operates in accordance with the state information management tables 21 (see FIG. 11 to FIG. 13) and the completion rule 22 (see FIG. 14), stored in the memory 20. In other words, the CLI control unit 18 is operated by the external console 3 located outside the storage device 1 through the network driver 15 and refers to the state information of the hardware 1B, which is collected by the state monitoring unit 16, thereby functioning as the input operation support device according to the present embodiment.

The GUI control unit 19 is operated by the external console 3 located outside the storage device 1 through the network driver 15 and fulfills a function to realize general GUI.

Next, a detailed functional configuration of the input operation support device according to the present embodiment applied to the storage device 1 illustrated in FIG. 8 will be described with reference to FIG. 10. FIG. 10 is a diagram illustrating configurations of the monitoring device and the input operation support device according to the present embodiment applied to the storage device 1 illustrated in FIG. 8. In FIG. 10, a configuration of only one of the CMs 1a in FIG. 8 is illustrated.

An input operation support system according to the present embodiment supports an operation of inputting an operation command for the storage device 1 and includes a monitoring device and an input operation support device, described later.

The monitoring device monitors the storage device 1 operated by inputting an operation command from the above-mentioned external console 3 and receives an instruction from the above-mentioned external console 3 to operate. As illustrated in FIG. 10, in addition to including the state monitoring unit 16 and the completion processing unit 18a in the CLI control unit 18, the monitoring device according to the present embodiment includes the state information management tables 21 (21a, 21b, and 21c) and the completion rule 22, located on the memory 20.

As illustrated in FIG. 8 and FIG. 10, the input operation support device according to the present embodiment is configured by the external console 3 including the input unit 3a, the display unit 3b, and the display control unit 3c. By operating the input unit 3a in the external console 3, the operator inputs an operation command for the storage device 1. At the time of inputting an operation command for the storage device 1, the display state of the display unit 3b in the external console 3 is controlled by the display control unit 3c, based on information relating to prioritized completion candidates output from the completion processing unit 18a on the storage device 1's side. At this time, as described above with reference to FIG. 5 to FIG. 7, the display control unit 3c controls, based on the information relating to the prioritized completion candidates, the display state of the display unit 3b so that the prioritized completion candidates are displayed in the display unit 3b in priority to other completion candidates among the completion candidates.

The CPU 10 (see FIG. 8) according to the present embodiment is a processing unit, which performs various kinds of control and calculation, and executes a predetermined application program (monitoring program) developed in the memory area of the memory 20. Thus, the CPU 10 fulfills functions as the state monitoring unit 16 and the completion processing unit 18a, in other words, fulfills functions as the monitoring device according to the present embodiment.

The predetermined application program is provided in the form of being recorded in a computer-readable recording medium such as, for example, a flexible disk, a compact disc (CD) including a CD read-only memory (CD-ROM), a CD recordable (CD-R), a CD rewritable (CD-RW), or the like, a digital versatile disc (DVD) including a DVD-ROM, a DVD-RAM, a DVD-R, a DVD-RW, a DVD+R, DVD+RW, or the like, or a Blu-ray disk. In this case, the CPU 10 reads and transfers the relevant predetermined application program from the relevant recording medium to the memory 20 (the memory area) serving as an internal storage device or an external storage device and stores therein and uses the relevant predetermined application program.

In the following description, “operation command” means a command in a state of being able to be issued to the storage device 1, in other words, a command which has been completed by the CLI completion function. In the example described in FIG. 5 and FIG. 6, “replace disks 103, 307” is an operation command, and in the example described in FIG. 7, “expand pool pool#3” is an operation command.

In the following description, “operation type” means a description indicating the type of an operation command. For example, in the operation command of “replace disks 103, 307”, “replace” is an operation type, and in the operation command of “expand pool pool#3”, “expand pool” is an operation type.

In the following description, “part type” means a description indicating a part type name for identifying the type of a part to which an operation command is applied. For example, in the operation command of “replace disks 103, 307”, “disks” is a part type, and the operation command of “expand pool pool#3” includes no part type.

In the following description, “part information” means a description indicating a part name or a part number for identifying a part to which an operation command is applied. For example, in the operation command of “replace disks 103, 307”, “103, 307” is part information, and in the operation command of “expand pool pool#3”, “pool#3” is part information.

The various kinds of parts (the hardware 1B) installed in the storage device 1 have states. The state monitoring unit 16 in the monitoring device according to the present embodiment monitors the states of the various kinds of parts (the hardware 1B) and sets and stores the monitoring results of the relevant states in the state information management tables 21 on the memory 20. In a case of detecting a change in a state, the state monitoring unit 16 instantaneously changes a state set and stored in the corresponding state information management table 21 with respect to a part (or a part type) having a state in which the relevant change occurs.

As the state information management tables 21, a state information management table 21a and a state information management table 21b as illustrated in FIG. 11 and FIG. 12, respectively, which store therein the states of individual parts with respect to each part type, are prepared. In addition, a state information management table 21c as illustrated in FIG. 13, which stores therein the states of parts having individual part types, may be prepared.

FIG. 11 is a diagram illustrating an example of the state information management table 21a (the state information of disks) with respect to the part type of “disks”. Each entry of the state information management table 21a illustrated in FIG. 11 includes a “disk number (part number)” item indicating a disk number serving as unique part information for identifying each disk and a “state” item indicating a state of a disk identified by the relevant disk number. As described above, the states of individual parts stored in the state information management table 21a illustrated in FIG. 11 are pieces of information relating to the levels (abnormal levels) of abnormal states occurring in the individual parts and are, for example, pieces of level information of four levels of “fatal”, “error”, “warning”, and “normal”. In the state information management table 21a illustrated in FIG. 11, “normal” is stored as the state of a disk having the disk number “000”, “fatal” is stored as the state of a disk having the disk number “001”, “not exist” is stored as the state of a disk having the disk number “002”, and “normal” is stored as the state of a disk having the disk number “003”. The state “not exist” indicates that a disk of a corresponding disk number is not installed.

FIG. 12 is a diagram illustrating an example of the state information management table 21b (the state information of a storage pool) with respect to the part type of “storage pool”. Each entry of the state information management table 21b illustrated in FIG. 12 includes a “pool number (part number)” item indicating a pool number serving as unique part information for identifying each storage pool and a “pool usage rate” item indicating a pool usage rate serving as a state of a pool identified by the relevant pool number. The states of individual pools stored in the state information management table 21b illustrated in FIG. 12 are pool usage rates (numerical information) relating to the individual pools. In the state information management table 21b illustrated in FIG. 12, “36%” is stored as the pool usage rate of a pool having the pool number “001”, “16%” is stored as the pool usage rate of a pool having the pool number “002”, “86%” is stored as the pool usage rate of a pool having the pool number “003”, and “2%” is stored as the pool usage rate of a pool having the pool number “004”.

FIG. 13 is a diagram illustrating an example of the state information management table 21c for managing the state information for each part type. Each entry of the state information management table 21c illustrated in FIG. 13 includes a “part type” (a part type name) item indicating a part type name for identifying each part type and a “state” item indicating a state of a part type identified by the relevant part type name. As described above, the states of parts having individual part types stored in the table 21c illustrated in FIG. 13 are pieces of information relating to the levels of abnormal states occurring in the individual part types, in particular, the highest abnormal levels, and are pieces of level information of four levels, for example, “fatal”, “error”, “warning”, and “normal”. In the table 21c illustrated in FIG. 13, “normal” is stored as the state of a part having the part type of “adapter”, “fatal” is stored as the state of a part having the part type of “disks”, and “warning” is stored as the state of a part having the part type of “ups”. At this time, as the state of a part having the part type of “disks”, for example, “fatal” serving as the highest abnormal level is extracted from among pieces of “state” stored in the state information management table 21a of the part type of “disks” illustrated in FIG. 11, and stored in the table 21c.

The CLI control unit 18 receives a connection request from the external console 3, analyzes a CLI command input from the external console 3, and arbitrarily executes processing in accordance with an analysis result.

In the CLI control unit 18, the completion processing unit 18a configuring the monitoring device according to the present embodiment performs the CLI completion processing in a case where execution of a completion operation (for example, the press-down operation of the TAB key) is detected. In particular, in accordance with the state of the storage device 1 monitored by the state monitoring unit 16, in other words, the state information in the state information management tables 21, the completion processing unit 18a fulfills a function as a completion candidate selection unit that selects prioritized completion candidates. That is, at the time of inputting an operation command, the completion processing unit 18a selects, in accordance with the above-mentioned state information, prioritized completion candidates from among completion candidates that may be included in the relevant operation command. Then, the completion processing unit 18a outputs, to the external console 3, information regarding the selected prioritized completion candidates. More specifically, the completion processing unit 18a selects prioritized completion candidates corresponding to the above-mentioned state information, from among a plurality of completion candidates likely to follow the character string input immediately before the completion operation (for example, the press-down operation of the TAB key). The above-mentioned completion candidates corresponding to the above-mentioned character string are preliminarily stored in the memory 20, and by searching the memory 20 with the above-mentioned character string as a key, it is possible for the completion processing unit 18a to acquire the above-mentioned completion candidates corresponding to the above-mentioned character string. The information regarding the relevant prioritized completion candidates, which is to be output to the external console 3, includes states (the above-mentioned state information) of the relevant prioritized completion candidates. The completion processing unit 18a outputs, to the external console 3, information regarding the completion candidates to which the relevant prioritized completion candidates belong and information relating to a priority described later.

As described above, in the external console 3 that receives an output from the completion processing unit 18a, the prioritized completion candidates are displayed in the display unit 3b in priority to other completion candidates among the completion candidates. Thus, in accordance with the above-mentioned state information, the prioritized completion candidates for the operation command are dynamically changed and displayed in the display unit 3b in the external console 3.

More specifically, the completion processing unit 18a and the display control unit 3c fulfill functions for at least the following items (a1) to (a4).

(a1) Upon receiving a completion operation subsequent to an operation type (for example, “replace”) of an operation command before inputting a part type (for example, “disks”) of an operation target part, the completion processing unit 18a functions as follows. In accordance with the operation type and the states of parts having individual part types, the completion processing unit 18a selects, as the prioritized completion candidates, the part types of operation target parts able to be input subsequent to the above-mentioned operation type, and outputs the part types of operation target parts to the external console 3. The display control unit 3c in the external console 3 preferentially displays the prioritized completion candidates output from the completion processing unit 18a in the display unit 3b (see FIG. 5). At this time, the completion processing unit 18a refers to, for example, the state information management table 21c as illustrated in FIG. 13 and the completion rule 22 that specifies prioritized completion candidates corresponding to the operation type and the states of parts having the individual part types, and selects the prioritized completion candidates in accordance with the relevant completion rule 22. The relevant completion rule 22 will be described later with reference to FIG. 14. At this time, the completion processing unit 18a selects the part types of parts whose abnormal level are high, as prioritized completion candidates whose priorities are correspondingly high. The completion processing unit 18a outputs, to the external console 3, information regarding the selected prioritized completion candidates and the priorities thereof. In the external console 3 that receives the relevant information, the part type of a part whose abnormal level is higher is preferentially displayed in the display unit 3b by the display control unit 3c (see FIG. 5).

(a2) Upon receiving a completion operation subsequent to an operation type (for example, “replace”) and a part type (for example, “disks”) of an operation command before inputting part information (for example, a disk number) for identifying an operation target part, the completion processing unit 18a functions as follows. In accordance with the operation type, the part type, and the states of individual parts, the completion processing unit 18a selects, as the prioritized completion candidates, the part information of operation target parts able to be input subsequent to the operation type and the part type, and outputs the part information to the external console 3. The display control unit 3c in the external console 3 preferentially displays the prioritized completion candidates output from the completion processing unit 18a in the display unit 3b (see FIG. 6). At this time, the completion processing unit 18a refers to, for example, the state information management table 21a as illustrated in FIG. 11 and the completion rule 22 that specifies prioritized completion candidates corresponding to the operation type, the part type, and the states of the individual parts, and selects the prioritized completion candidates in accordance with the relevant completion rule 22. The relevant completion rule 22 will be described later with reference to FIG. 14. At this time, the completion processing unit 18a selects the part information (disk number) of parts whose abnormal levels are high, as prioritized completion candidates whose priorities are correspondingly high. The completion processing unit 18a outputs, to the external console 3, information regarding the selected prioritized completion candidates and the priorities thereof. In the external console 3 that receives the relevant information, the part information of a part whose abnormal level is higher is preferentially displayed in the display unit 3b by the display control unit 3c (see FIG. 6).

(a3) Depending on the operation type, the completion processing unit 18a selects the part information of parts as prioritized completion candidates in accordance with the numerical information (for example, a pool usage rate) at the time of an completion operation, and outputs the part information to the external console 3. The display control unit 3c in the external console 3 preferentially displays the prioritized completion candidates output from the completion processing unit 18a in the display unit 3b. For example, upon receiving a completion operation in a case where an operation command including an operation type and a part type is an expansion command (for example, an “expand pool” command) for a storage pool in the storage device 1 serving as the operation target, the completion processing unit 18a functions as follows. The completion processing unit 18a refers to, for example, the state information management table 21b as illustrated in FIG. 12 and the completion rule 22 that specifies prioritized completion candidates with respect to the “expand pool” command, and selects the prioritized completion candidates in accordance with the relevant completion rule 22. The relevant completion rule 22 will be described later with reference to FIG. 14. At this time, the completion processing unit 18a selects the part information (pool numbers) of storage pools whose usage rates are high, as prioritized completion candidates whose priority is correspondingly high. The completion processing unit 18a outputs, to the external console 3, information regarding the selected prioritized completion candidates and the priorities thereof. In the external console 3 that receives the relevant information, the part information (pool numbers) of storage pools whose usage rates are higher is preferentially displayed in the display unit 3b by the display control unit 3c (see FIG. 7).

(a4) Along with prioritized completion candidates, the completion processing unit 18a outputs, to the external console 3, states of the relevant prioritized completion candidates, which serve as reasons why the relevant prioritized completion candidates are preferentially displayed. The display control unit 3c in the external console 3 causes the display unit 3b to supplementarily display the above-mentioned states output from the completion processing unit 18a. In other words, as illustrated in the second line in FIG. 5 or FIG. 6, the display control unit 3c causes the display unit 3b to supplementarily display, as the states of the relevant prioritized completion candidates, “(fatal)” and “(warning)” subsequent to the display of completion candidates. In a case where an operation command to be input is the “expand pool” command or the like, as illustrated in the second line in FIG. 7, the display control unit 3c causes the display unit 3b to supplementarily display the pool usage rates “(86%)”, “(36%)”, “(16%)”, and “(2%)” serving as the numerical information after the display of respective completion candidates, as the states of the relevant completion candidates.

According to the present embodiment, as a method of prioritized display, the display control unit 3c adopts a method of displaying the part types and the pieces of part information in descending order of abnormal level and a method of displaying the pool numbers in descending order of usage rate. In addition to the relevant methods, the display control unit 3c may adopt a method of highlighting by changing the display color, the display size, the display luminance, or the like of a part type or the part information in accordance with the abnormal level thereof or a method of highlighting by changing the display color, the display size, the display luminance, or the like of a pool number in accordance with the usage rate thereof.

Next, the completion rule 22 referred to by the completion processing unit 18a at the time of determining prioritized completion candidates will be described with reference to FIG. 14. FIG. 14 is a diagram illustrating an example of the completion rule 22 according to the present embodiment.

According to the present embodiment, in order to deal with the completion processing of the operation type, the part type, and the part information of each operation command, the completion rule 22 for defining how to execute the completion processing for each completion base is preliminarily specified and stored in the memory 20, as illustrated in FIG. 14. Each entry of the completion rule 22 illustrated in FIG. 14 includes a “completion base” item a “completion candidate” item, a “completion criterion” item, a “completion rank order” item, and a “supplementary display target” item.

In the “completion base” item, an operation type of the target which is required, by the operator, to be completed is specified. For example, “replace”, “replace disks”, and “expand pool” are specified in “completion base”. In the “completion candidate” item, information to be displayed as completion candidates is specified. In the “completion criterion” item, information to serve as a criterion for determining the rank order of prioritized display is specified. In the “completion rank order” item, specific rank orders conforming to “completion criterion” and flags each indicating whether or not to perform supplementary display are specified. In the “supplementary display target” item, information to be supplementarily displayed in a case of performing the relevant supplementary display is specified.

In the completion rule 22, in a case where the completion base is “replace”, information to be displayed as the corresponding prioritized completion candidates are part types, the corresponding completion criterion is a state, and the corresponding supplementary display target is a state. As for the corresponding completion rank order, the “fatal” state is specified as the first rank with a designation of performing the supplementary display (supplementary display flag-on). The “error” state is specified as the second rank with the supplementary display flag-on. The “warning” state is specified as the third rank with the supplementary display flag-on. The “normal” state is specified as the fourth rank with supplementary display flag-off. Furthermore, in the completion rank order, it is specified that a part type in a state (for example, a “not exist” state indicating that no part of the part type is installed) other than the above-mentioned first rank to fourth rank is exempt from the prioritized completion targets, in other words, is not caused to be displayed in the display unit 3b.

Completion processing operations (b1) to (b5) subsequent to an input of a “replace” command, which are to be executed in accordance with the completion rule 22, will be hereinafter described.

(b1) If the operator presses down the TAB key subsequent to the input of “replace” (see the first line in FIG. 5), the completion processing unit 18a in the CLI control unit 18 starts the completion processing for the operation type of “replace”.

(b2) The completion processing unit 18a confirms, in the completion rule 22, the completion candidate, the completion criterion, the completion rank order, and the supplementary display target of an entry corresponding to the completion base of “replace”.

(b3) The completion processing unit 18a reads the state information management table 21c (see FIG. 13) corresponding to “part type” specified as the completion candidate.

(b4) In accordance with the corresponding completion criterion of “state” and the corresponding completion rank order, the completion processing unit 18a sorts the state information for respective part types, which is described in the state information management table 21c, and outputs, as information regarding the prioritized completion candidates, a sort result and the corresponding supplementary display flags, to the external console 3.

(b5) The display control unit 3c in the external console 3 causes the display unit 3b to display individual part types in order of being sorted in (b4) (see the second line in FIG. 5). At that time, in the case of the supplementary display flag-on, the display unit 3b is caused to display “(fatal)”, “(warning)”, and so forth serving as information relating to “state” (see the second line in FIG. 5). Part types in the “normal” state are displayed in alphabetical order, subsequent to the prioritized display of part types (see the three to sixth lines in FIG. 5).

In the completion rule 22, in a case where the completion base is “replace disks”, information to be displayed as the corresponding prioritized completion candidates are disk numbers, the corresponding completion criterion is a state, and the corresponding supplementary display target is a state. The corresponding completion rank order is specified in the same way as in the case where the corresponding completion base is “replace”.

Completion processing operations (c1) to (c5) subsequent to an input of a “replace disks” command, which are to be executed in accordance with the completion rule 22, will be hereinafter described.

(c1) If the operator presses down the TAB key subsequent to the input of “replace disks” (see the first line in FIG. 6), the completion processing unit 18a in the CLI control unit 18 starts the completion processing for the operation type of “replace disks”.

(c2) The completion processing unit 18a confirms, in the completion rule 22, the completion candidate, the completion criterion, the completion rank order, and the supplementary display target of an entry corresponding to the completion base of “replace disks”.

(c3) The completion processing unit 18a reads the state information management table 21a (see FIG. 11) corresponding to “disk number” specified as the completion candidate.

(c4) In accordance with the corresponding completion criterion of “state” and the corresponding completion rank order, the completion processing unit 18a sorts the state information for respective disk numbers, which is described in the state information management table 21a, and outputs, as information regarding the prioritized completion candidates, a sort result and the corresponding supplementary display flags, to the external console 3.

(c5) The display control unit 3c in the external console 3 causes the display unit 3b to display individual disk numbers in order of being sorted in (c4) (see the second line in FIG. 6). At that time, in the case of the supplementary display flag-on, the display unit 3b is caused to display “(fatal)” and so forth serving as information relating to “state” (see the second line in FIG. 6). Disk numbers in the “normal” state are displayed in ascending order, subsequent to the prioritized display of disk numbers (see the three to sixth lines in FIG. 6). In FIG. 6 and FIG. 11, disk numbers in the “fatal” state do not correspond to each other.

In the completion rule 22, in a case where the completion base is “expand pool”, information to be displayed as the corresponding prioritized completion candidates are pool names (pool numbers), the corresponding completion criterion is a pool usage rate, and the corresponding supplementary display target is a pool usage rate. In addition, it is specified that the corresponding completion rank order is the descending order of the pool usage rate and the supplementary display flag is turned on.

Completion processing operations (d1) to (d5) subsequent to an input of an “expand pool” command, which are to be executed in accordance with the completion rule 22, will be hereinafter described.

(d1) If the operator presses down the TAB key subsequent to the input of “expand pool” (see the first line in FIG. 7), the completion processing unit 18a in the CLI control unit 18 starts the completion processing for the operation type of “expand pool”.

(d2) The completion processing unit 18a confirms, in the completion rule 22, the completion candidate, the completion criterion, the completion rank order, and the supplementary display target of an entry corresponding to the completion base of “expand pool”.

(d3) The completion processing unit 18a reads the state information management table 21b (see FIG. 12) corresponding to “pool name (pool number)” specified as the completion candidate.

(d4) In accordance with the corresponding completion criterion of “pool usage rate” and the corresponding completion rank order of “descending order”, the completion processing unit 18a sorts the numerical information “pool usage rate” for respective pool names (pool numbers), which is described in the state information management table 21b, and outputs, as information regarding the prioritized completion candidates, a sort result and the corresponding supplementary display flags, to the external console 3.

(d5) The display control unit 3c in the external console 3 causes the display unit 3b to display individual pool names (pool numbers) in order of being sorted in (d4) (see the second line in FIG. 7). At that time, in the case of the supplementary display flag-on, the display unit 3b is caused to display “pool usage rate” (see the second line in FIG. 7).

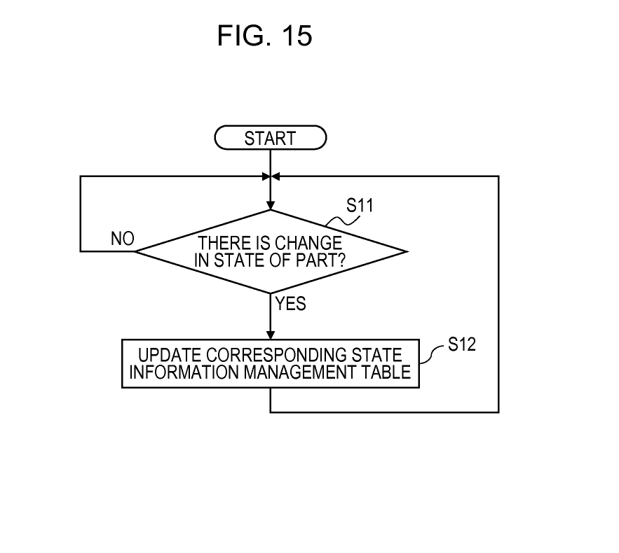

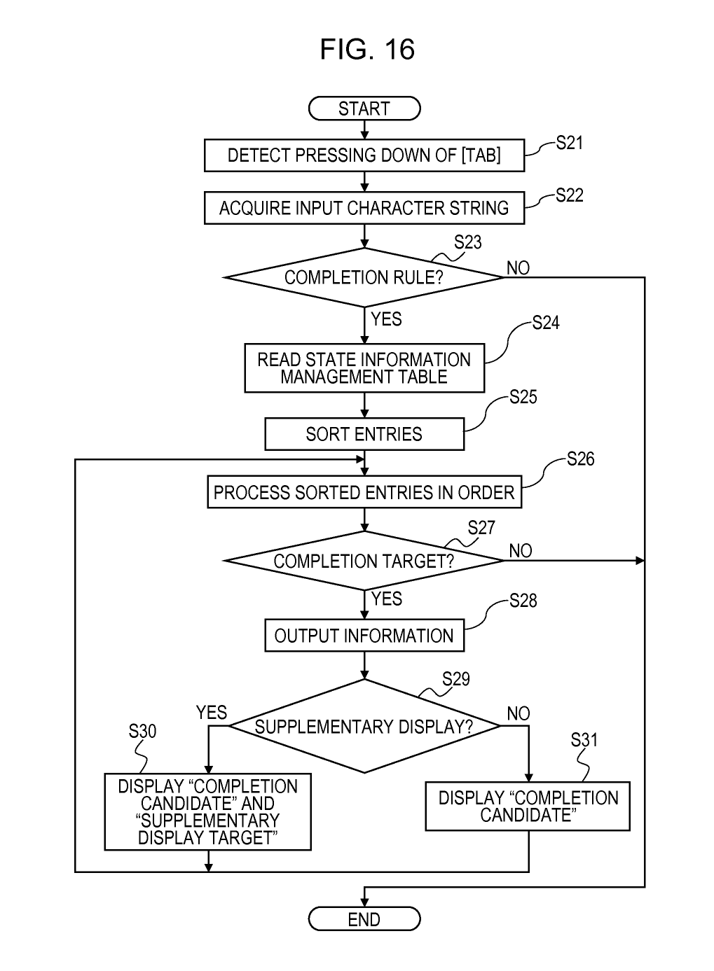

Next, the operation of the input operation support system according to the present embodiment will be described with reference to FIG. 15 and FIG. 16.

First, in accordance with a flowchart illustrated in FIG. 15, state monitoring processing performed by the state monitoring unit 16 in the monitoring device according to the present embodiment will be described.

During the operation of the storage device 1 serving as an operation target device, the state monitoring unit 16 continuously monitors the various kinds of parts (the hardware 1B) installed in the storage device 1 (S11). In a case where a change in a state of one of the parts is detected (S11: YES), the state monitoring unit 16 instantaneously changes the state information in the corresponding state information management table 21 with respect to a part (or a part type) having the state in which the relevant change occurs (S12). The state monitoring unit 16 repeatedly performs such processing. Thus, the state information management tables 21a, 21b, and 21c as illustrated in FIG. 11 to FIG. 13, for example, are stored as the state information management tables 21 in the memory 20.

Next, the completion processing based on performed by the completion processing unit 18a in the monitoring device according to the present embodiment and the external console 3 as the input operation support device according to the present embodiment will be described in accordance with a flowchart illustrated in FIG. 16.

Upon detecting the press-down operation of the TAB key (S21), the completion processing unit 18a acquires a character string input before the pressing down of the TAB key (S22) and refers to the completion rule 22, thereby determining whether or not a completion rule corresponding to the input character string exists (S23). In a case where no completion rule exists (S23: NO), the completion processing unit 18a terminates the processing.

In a case where the corresponding completion rule exists (S23: YES), the completion processing unit 18a reads the state information management table 21 (21a, 21b, or 21c) corresponding to the completion candidate of the completion rule (S24). The completion processing unit 18a sorts each entry in the state information management table 21 on the basis of the completion criterion and the completion rank order of the completion rule (S25).

The completion processing unit 18a performs the following processing operations in S27 to S31 for the entries sorted in S25, in order (S26). First, the completion processing unit 18a determines whether or not the relevant entry is a completion target (S27). In a case where the relevant entry is not a completion target (S27: NO), the completion processing unit 18a terminates the processing.

In a case where the relevant entry is a completion target (S27: YES), the completion processing unit 18a outputs information regarding the relevant entry, to the external console 3 (S28). The display control unit 3c in the external console 3 that receives the information regarding the relevant entry determines whether or not supplementary display is to be performed for the relevant entry, in other words, whether or not the supplementary display flag is turned on (S29). In a case where the supplementary display flag is turned on (S29: YES), the display control unit 3c causes the display unit 3b to display, as a prioritized completion candidate, the completion candidate and the supplementary display target in conjunction with each other (S30) and returns to the processing operation in S26. In a case where the supplementary display flag is turned off (S29: NO), the display control unit 3c causes the display unit 3b to display, as a prioritized completion candidate, only the completion candidate (S31) and returns to the processing operation in S26.

As described above, according to the input operation support system (the monitoring device and the input operation support device) according to the present embodiment, the CLI completion function is used, thereby dynamically changing display of prioritized completion candidates in response to the state of each part installed in the storage device 1. Therefore, it is possible to reliably suppress the occurrences of operation mistakes by the operator in managing an appliance. Thus, it becomes possible to correctly perform the input of an operation command without increasing a load on the operator even if the number of commands or parts serving as choices is increased.

As described above, the operability of the CLI function installed in the appliance device is improved and it is possible to perform more efficient management or setting. Even if the operator is unfamiliar with input operations based on CLI, the operator is guided to input a more appropriate operation command. Therefore, the occurrences of operation mistakes are reliably suppressed and the input operation support system (the monitoring device and the input operation support device) according to the present embodiment effectively functions.

In particular, according to the present embodiment, in order to suppress the occurrences of operation mistakes and so forth by expanding the general CLI completion function, the state information of the operation target device is used, which serves as an element important in managing the operation target device such as an appliance device. In other words, the prioritized completion candidates of an operation command are selected using the real-time state information at the time point of executing the relevant operation command and dynamically displayed in the display unit 3b. Therefore, it is possible to determine and display, in real time, candidates each having a high possibility to be used by the operator at each time point. Thus, it becomes possible for the operator to use the CLI function with a smaller operation amount and adequate completion candidates to be specified are preferentially displayed, thereby enabling to reliably suppress the occurrences of operation mistakes.

According to the present embodiment, based on the various kinds of state information of the device at the time of executing the completion processing, commands and parameters (a part type, a part number, and so forth) whose frequencies of usage are high are preferentially displayed. Specifically, it is possible for the operator to reliably recognize disks in the “fatal” state from among the part numbers subjected to the prioritized display in, for example, the second line of FIG. 6, and it is possible for the operator to correctly input the part numbers “103” and “307” of the recognized disks subsequent to “replace disks” in the seventh line in FIG. 6. In addition, it is possible for the operator to reliably recognize the pool number of a storage pool whose usage rate is high from among the pool numbers subjected to the prioritized display in the second line FIG. 7, and it is possible for the operator to correctly input the recognized pool number subsequent to “expand pool” in the third line in FIG. 7.

### Other Embodiments

While the first embodiment is described in detail, the embodiments are not limited to such a specific embodiment and may be variously altered or modified and implemented without departing from the scope of the first embodiment.

While information relating to the abnormal level or the numerical information relating to the usage rate or the like of a storage pool is used as the state of each part or the state of each part type in the first embodiment, the embodiments are not limited to this.

While the operation target device is a storage device in the first embodiment, the embodiments are not limited to this. If the operation target device is a standardized appliance device such as, for example, a network switch, a server for a network, a cache server, a router, a file server, an encryption device, a home-use game console, or a terminal dedicated to web browsing or transmission and reception of mails, the technology in the first embodiment may be applied in the same way and it is possible to obtain the same effect as that in the first embodiment.

Furthermore, the operation target device to which the present technology is applied is not limited to the appliance device. The present technology may be applied to a general personal computer, a workstation, and so forth in the same way as in the first embodiment and it is possible to obtain the same effect as that in the first embodiment.

In the first embodiment, a case is described where the state monitoring unit 16 and the completion processing unit 18a configuring the monitoring device are provided in the operation target device (storage device 1) and the input operation support device is configured by the external console 3 separated from the operation target device and connected to the operation target device. However, the present technology is not limited to this. For example, the input operation support device (a function as the external console 3) may be included in the operation target device (storage device 1), and in this case, it is possible to obtain the same effect as that in the above-mentioned embodiment. Furthermore, the input operation support device (external console 3) may be configured so as to include a function as the completion processing unit 18a (completion candidate selection unit), receive the state information from the state monitoring unit 16 on the operation target device's side, and select prioritized completion candidates. In this case, it is possible to obtain the same effect as that in the first embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A monitoring device, comprising:
a processor configured to
monitor a state of a first device,
receive an operation command input partway, the operation command being for operating the first device,
select, depending on the state of the first device, a prioritized completion candidate from among a plurality of completion candidates likely to be included in the operation command, the prioritized completion candidate being to be displayed in a display unit in priority to other completion candidates among the plurality of completion candidates, and
output information regarding the prioritized completion candidate.

2. The monitoring device according to claim 1, wherein
the processor is configured to
monitor states of parts included in the first device for respective part types of the parts, and
select depending on an operation type of the operation command and the monitored states, when the operation type has been input and a subsequent input of a part type of a target part is not yet performed, the prioritized completion candidate from among first part types likely to be input subsequent to the operation type.

3. The monitoring device according to claim 2, wherein
the processor is configured to
select the prioritized completion candidate in accordance with a completion rule for selecting the prioritized completion candidate to be input subsequent to the operation type depending on the monitored states.

4. The monitoring device according to claim 2, wherein
the processor is configured to
monitor abnormal levels of the parts for the respective part types of the parts, the abnormal levels indicating levels of abnormality, and
select, as the prioritized completion candidate, a part type of a first part having a highest abnormal level among the parts.

5. The monitoring device according to claim 1, wherein
the processor is configured to
monitor states of respective parts included in the first device, and
select depending on an operation type of the operation command, a part type of a target part, and the monitored states, when the operation type and the part type have been input and a subsequent input of a part identifier for identifying the target part is not yet performed, the prioritized completion candidate from among part identifiers likely to be input subsequent to the part type.

6. The monitoring device according to claim 5, wherein
the processor is configured to
select the prioritized completion candidate in accordance with a completion rule for selecting the prioritized completion candidate to be input subsequent to the operation type and the part type depending on the monitored states.

7. The monitoring device according to claim 5, wherein
the processor is configured to
monitor abnormal levels of the respective parts, the abnormal levels indicating levels of abnormality, and
select, as the prioritized completion candidate, a part identifier of a first part having a highest abnormal level among the parts.

8. The monitoring device according to claim 5, wherein
the states of the respective parts are indicated by numerical information.

9. The monitoring device according to claim 8, wherein
the operation command is an expansion command for expanding a storage pool including storage devices, and
the numerical information indicates usage amounts or usage rates of respective storage pools included in the first device.

10. The monitoring device according to claim 1, wherein
the information regarding the prioritized completion candidate includes information indicating a state of the prioritized completion candidate.

11. A computer-readable recording medium having stored therein a program for causing a computer to execute a process, the process comprising:
monitoring a state of a first device;
receiving an operation command input partway, the operation command being for operating the first device;
selecting depending on the state of the first device, a prioritized completion candidate from among a plurality of completion candidates likely to be included in the operation command, the prioritized completion candidate being to be displayed in a display unit in priority to other completion candidates among the plurality of completion candidates; and
outputting information regarding the prioritized completion candidate.

12. The computer-readable recording medium according to claim 11, the process comprising:
monitoring states of parts included in the first device for respective part types of the parts; and
selecting depending on an operation type of the operation command and the monitored states, when the operation type has been input and a subsequent input of a part type of a target part is not yet performed, the prioritized completion candidate from among first part types likely to be input subsequent to the operation type.

13. The computer-readable recording medium according to claim 12, the process comprising:
selecting the prioritized completion candidate in accordance with a completion rule for selecting the prioritized completion candidate to be input subsequent to the operation type depending on the monitored states.

14. The computer-readable recording medium according to claim 12, the process comprising:
monitoring abnormal levels of the parts for the respective part types of the parts, the abnormal levels indicating levels of abnormality; and
selecting, as the prioritized completion candidate, a part type of a first part having a highest abnormal level among the parts.

15. The computer-readable recording medium according to claim 11, the process comprising:
monitoring states of respective parts included in the first device; and
selecting depending on an operation type of the operation command, a part type of a target part, and the monitored states, when the operation type and the part type have been input and a subsequent input of a part identifier for identifying the target part is not yet performed, the prioritized completion candidate from among part identifiers likely to be input subsequent to the part type.

16. The computer-readable recording medium according to claim 15, the process comprising:
select the prioritized completion candidate in accordance with a completion rule for selecting the prioritized completion candidate to be input subsequent to the operation type and the part type depending on the monitored states.

17. An input operation support device, comprising:
a display unit; and
a processor configured to
receive an operation command input partway, the operation command being for operating a first device,
select, depending on a state of the first device, a prioritized completion candidate from among a plurality of completion candidates likely to be included in the operation command, and
display the prioritized completion candidate in the display unit in priority to other completion candidates among the plurality of completion candidates.

18. The input operation support device according to claim 17, wherein the processor is configured to
monitor states of parts included in the first device for respective part types of the parts,
select depending on an operation type of the operation command and the monitored states, when the operation type has been input and a subsequent input of a part type of a target part is not yet performed, a first part type from among a plurality of part types likely to be input subsequent to the operation type, and
display the first part type in the display unit in priority to other part types among the plurality of part types.

19. The input operation support device according to claim 18, wherein
the states of the parts are abnormal levels of the parts, the abnormal levels indicating levels of abnormality, and
the first part type is a part type of a first part having a highest abnormal level among the parts.

20. The input operation support device according to claim 17, wherein
the processor is configured to
monitor states of respective parts included in the first device,
select depending on an operation type of the operation command, a part type of a target part, and the monitored states, when the operation type and the part type have been input and a subsequent input of a part identifier for identifying the target part is not yet performed, a first part identifier from among a plurality of part identifiers likely to be input subsequent to the part type, and
display the first part identifier in the display unit in priority to other part identifiers among the plurality of part identifiers.
